(19) United States
(12) Patent Application Publication
(10) Pub. No.: US 2021/0209531 A1
(43) Pub. Date: Jul. 8, 2021

(54) REQUIREMENT CREATION USING SELF LEARNING MECHANISM

(71) Applicant: INTERNATIONAL BUSINESS MACHINES CORPORATION, Armonk, NY (US)

(72) Inventors: Deepak Gupta, Uttar Pradesh (IN); Namita Gupta, Delhi (IN); Siddharth K. Saraya, West Bengal (IN)

(21) Appl. No.: 16/736,256

(22) Filed: Jan. 7, 2020

(51) Int. Cl. G06Q 10/06; G06F 16/951; G06N 20/00

(52) U.S. Cl. CPC G06Q 10/06313; G06N 20/00; G06F 16/951

(57) ABSTRACT

A computer implemented method of creating a requirement document that may begin with receiving data feeds for requirement data correlated to historical projects; and using natural language processing to extract requirement data correlated to project type from the historical projects. The project types are tagged with the requirement data and stored in a database of tagged requirements to project type. A project description is analyzed for project type using natural language processing to extract the project type. The method further includes matching the project type extracted from the project description to the tagged requirements of project type. A report is generated of requirements including the tagged requirements matching the project type extracted from the project description.

### BACKGROUND

The present invention generally relates to information processing, and more particularly to setting requirements for project implementation.

Requirements are business needs documented into a form that can be picked up by a technical team for implementation. While many of such requirements are specific to the project in question, there are many requirements which depend on the technology, e.g., web based, mobile development, etc. Requirements may also be specific to a domain. For example, the requirements may be specific to an industry. Requirements may also be location specific. Examples of these types of requirements can include regulatory requirements and/or country laws.

Requirements can be architectural, business, user, functional, quality of service, implementation; and a good requirement must be unitary, complete, consistent, atomic, traceable, current, unambiguous, verifiable and specify importance.

### SUMMARY

In accordance with one aspect of the present disclosure, methods, and computer program products have been provided that employ machine learning to create requirement documents that correspond to specific project types.

In one embodiment, the computer implemented method of creating a requirement document may begin with receiving data feeds for requirement data correlated to historical projects; and using natural language processing to extract requirement data correlated to project type from the historical projects. The project types are tagged with the requirement data and stored in a database of tagged requirements to project type. A project description is analyzed for project type using natural language processing to extract the project type. The method further includes matching the project type extracted from the project description to the tagged requirements of project type. A report is generated of requirements including the tagged requirements matching the project type for the project description.

In another aspect, the present disclosure provides a system for generating a requirements report. In one embodiment, the system includes a learning engine comprising a learning receiver for data feeds for requirement data correlated to historical projects, a natural language classifier that employs natural language processing to extract requirement data correlated to project type from the historical projects, and a tag writer for tagging project types with the requirement data. The system also includes a requirement generator including a receiver for receiving a project description that is analyzed using natural language processing to extract the project type, a comparator for matching the project type extracted from the project description to the tagged requirements of project type, and a report generator for generating a report of requirements including the tagged requirements matching the project type extracted from the project description.

In yet another aspect, a computer program product is provided that includes a computer readable storage medium having computer readable program code embodied therein for creating a requirement document. In one embodiment, the computer readable storage medium is non-transitory. The computer readable program code can provide the steps may include receiving data fees for requirement data correlated to historical projects; and using natural language processing to extract requirement data correlated to project type from the historical projects. The project types are tagged with the requirement data and stored in a database of tagged requirements to project type. A project description is analyzed for project type using natural language processing to extract the project type. The method further includes matching the project type extracted from the project description to the tagged requirements of project type. A report is generated of requirements including the tagged requirements matching the project type extracted from the project description.

### BRIEF DESCRIPTION OF THE DRAWINGS

The following description will provide details of preferred embodiments with reference to the following figures wherein:

FIG. 1 is an illustration of an environment for one application of the methods and systems for produce a requirements document that are described herein, in accordance with on embodiment of the present disclosure.

FIG. 2 is a flow diagram showing a method to produce a requirements document for a project, in accordance with the present disclosure.

FIG. 3 is a flow/block diagram depicting a first embodiment of a system for providing a requirements document for a project, in accordance with the present disclosure.

FIG. 4 is a block diagram illustrating a processing system that can incorporate the system for providing a requirement depicted in FIG. 3, in accordance with one embodiment of the present disclosure.

FIG. 5 depicts a cloud computing environment according to an embodiment of the present disclosure.

FIG. 6 depicts abstraction model layers according to an embodiment of the present disclosure.

### DETAILED DESCRIPTION

The methods, systems, and computer program products described herein can provide for requirement creation using self-learning mechanisms. Requirements can consume a portion of a project life cycle; and accuracy of the requirements is a success factor in any project. Failure to meet requirements can be a major root cause of failure for a project. For example, ineffective and incomplete requirements can lead to problems in projects, and impacts the projects in terms of schedule, cost, and effort. Time and effort are consumed during the requirements phase, and many times the time spend on the requirements phase overlaps with the design phase and/or the build phase of a project, e.g., in order to meet a schedule. This can result in the occurrence of requirement defects and design defects into the project. In some instances, incomplete or ambiguous requirements lead to scope creep and the negative impacts resulting therefrom.

In some embodiments, a certain set of requirements can be left assumed and hence be undocumented. Requirements can be dependent upon the technology. For example, domains etc. can be automated. Requirements can also change with time. For example, country laws can be newly formed following the first instance of a requirement; or benchmarks for industry standards can be changed. New versions of internet browsers can be released, which can also change the requirement of a project; or new platforms can be launched that can change the requirement of a project. In some instances, new best practices of an organization or industry can impact requirements. New requirements for one project can also be learned from other projects. Additionally, there are requirements that are “assumed”, however in several scenarios and instances, a requirement for a project can be escalated because a customer believes a “basic” requirement was not present in the solution.

As will be described herein, the methods, systems and computer program products of the present disclosure provide a requirement first product that initializes the requirement document based on its domain, technology, as well as other industry type considerations. The requirement first product can learn the requirements based on new best practices (either provided as input, by crawling the internet, or through analysis of prior requirement documents). The requirement first product can also review rules & regulations, and through tagging of requirements by the users learn the requirements for a new project.

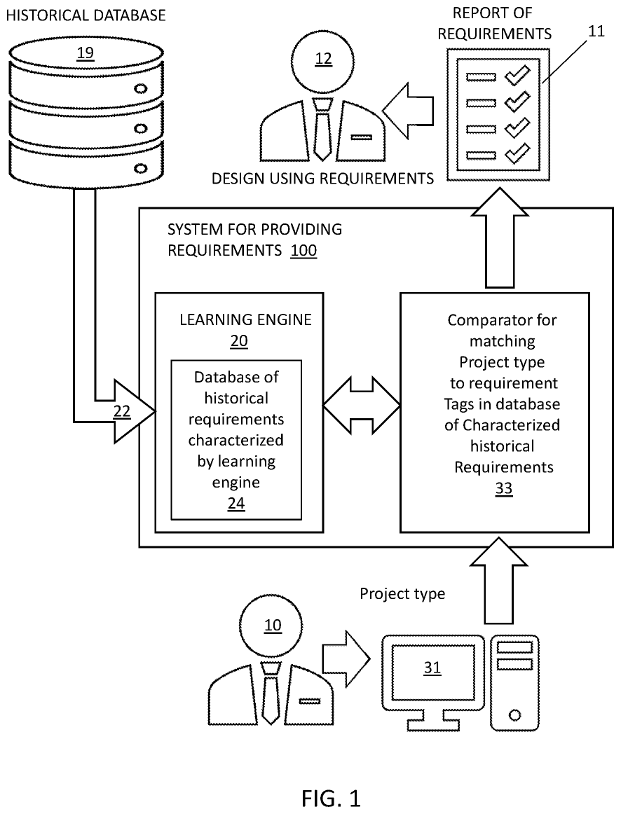

The methods and systems of the present disclosure are now described in greater detail with reference to FIGS. 1-6.

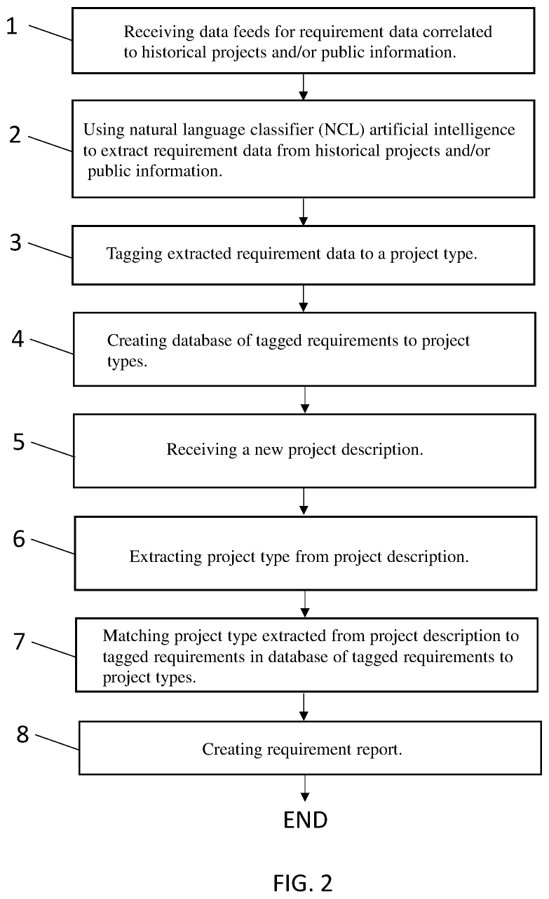

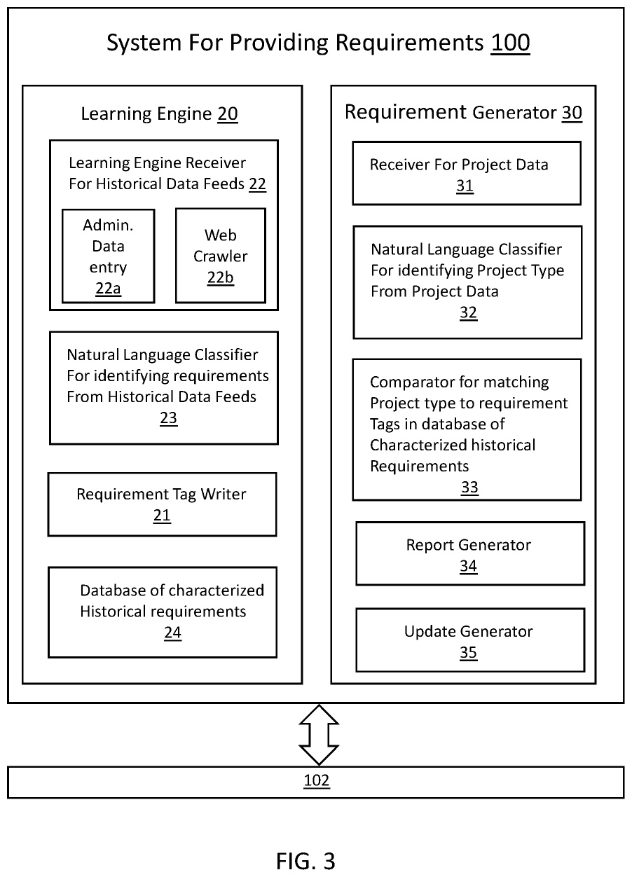

FIG. 1 is an illustration of one embodiment of a general environment in which the methods and systems of providing a requirements document may function. FIG. 2 is a flow diagram showing a method by which a system 100 can produce a requirements document for a project. FIG. 3 is a flow/block diagram depicting an embodiment of a system 100 for providing a requirements document for a project.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, the implementation of the method may include a step of self-learning and building base data. FIG. 1 illustrates an historical database 19 being employed by a learning engine 20 to generate a database of historical requirements characterized, e.g., tagged, by the learning engine 24. The process of self-learning and building base data may include blocks 1, 2, 3 and 4 of the method depicted in FIG. 2. The process of self-learning and data base building that can be provided by blocks 1, 2, 3 and 4 of the method depicted in FIG. 2 may be performed by a learning engine 20 of the system for providing requirements 100 that is depicted in FIG. 3.

For example, during projects, such as historical projects, requirements can be tagged with a few parameters. Tagging may be actuated by a requirement tag writer 21 of the system 100 for providing requirements.

Examples of parameters for requirements for technology may include Java and/or browser. Examples of requirements for an industry or domain may include banking, and credit card industries. Examples of types of requirements include architectural, business, user, functional, quality of service, and implementation. The requirements that can be tagged may also include whether the requirement is one of a regulatory type, e.g., is a regulatory requirement, is not a regulatory requirement, and the tagged requirement may consider a country mapping of regulations. The tagging may include a score of ambiguity. The tagging may also include a location for the requirement, such as a country, city etc. It is further noted that the tagging may include any combinations of the above parameters for the requirements.

In some embodiments, the process of self-learning and building base data may include tracking requirements of historical projects. This process can include receiving data feeds for requirement data that is correlated to historical projects, publicly available data accessible through the internet and/or internal data specific to the user of the system 100. FIG. 1 illustrates a historical database 19 for providing these data feeds. It is noted that FIG. 1 illustrates only one embodiment of the present disclosure, and that the present disclosure is not limited to only this example for the data feeds. This step is depicted in block 1 which includes receiving data feeds for requirement data correlated to historical projects and/or public information, as depicted in FIG. 2. The data feeds may be received for the learning engine 20 through a learning engine receiver for data feeds 22, which can include both inputs from an administrative data entry 22a input, and a web crawler 22b input, as depicted in FIGS. 1 and 3. Through these inputs, the learning engine 20 may be fed multiple requirements along with the project domain, technology and other aspects.

In some embodiments, system 100 will learn requirements from regulations by crawling the internet via the web crawler 22b. Internet based requirement data can include rules and regulations, news items, and social media etc., which may all be accessed over the internet. For example, news of mobile companies reimbursing a consumer for call drops can provide a requirement on performance for a project working on mobile domains for designing tower placements. Content analysis from internet sources can also help identify new or best practices. For example, a discussion on an internet based message board on reverse captcha can be captured as a requirement for authentication.

In some embodiments, the system can look up standard best practices of an organization, which in some embodiments the user of the system 100 may be a member of. In one embodiment, the user, e.g., an administrator, can manually feed requirement information to the system, e.g., through the administrator data entry 22a input.

Referring to FIGS. 1 and 3, the system 100 derives requirements from the data feeds (received through the learning engine receiver for data feeds 22) using artificial intelligence (AI) to provide a database of learned relationships between requirements (which may be referred to as a database of historical requirements 24), which are tagged. The tag may designate the type of projects and/or documents that include the historical requirements. Referring to FIG. 2, the step of extracting requirement data may be provided by block 2, which includes using the natural language classifier (NCL) artificial intelligence to extract requirement data from historical projects and/or public information.

For example, the system can employ natural language classifier (NLC) capabilities, e.g., provided by a natural language classifier 23, to recognize requirements from data that has been fed through the data feed into the system, and tags the requirements according to the technology, domain etc.

Referring to FIG. 2, the natural language classifier 23 may include an ensemble of machine learning techniques. NLC models include multiple Support Vector Machines (SVMs) and a Convolutional Neural Network (CNNs). The natural language classifier 23 can employ at least one hardware device processor for performing a set of instruction stored on at least one memory device, in which the cognitive computing engine analyzes the data from the social media accounts 20 and calendars 15 and assigns weights to the data. As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Referring to FIG. 2, the method may continue to block 3, which includes tagging extracted requirement data to a project type. The tag may designate the type of projects and/or documents that include the historical requirements. One example of tagging may include that a Solvency II requirement will be tagged to “Insurance+Data Warehouse”; while Browser version 3.2 or above will be tagged to all “eCommerce”, “Java”, etc. For example, BASEL II requirement seen across Banking projects with account storage will be tagged to “Banking+Data Warehouse” projects. Cognitive capabilities in conjunction with the tagging of requirements is a key differentiator which will create a large set of automated requirements for new projects.

Referring to FIG. 2, at block 4 of the method for producing a requirement document, the process can continue to create a database of tagged requirements to project types. Referring to FIGS. 1 and 3, the system for providing requirements 100 includes a database of historical requirements 24 for storing the data for the tagged requirements to the project types. The database of historical requirements 24 may be stored on any type of memory, such as hardware memory that can include, but is not limited to random access memory (RAM), a read-only memory (ROM), an erasable programmable read-only memory (EPROM or Flash memory), a static random access memory (SRAM) and combinations thereof. The database of tagged requirements to project types is used in the execution of new projects for setting requirements.

Following the formation of the database of tagged requirements to project types at block 4, the tagged requirements may be used in an execution stage of the method that includes blocks 5, 6, 7 and 8 of FIG. 2.

Referring to block 5 of FIG. 2, execution of the method for providing a requirements first product may include entering a new project description into the system 100.

FIG. 1 illustrates one example of a user 10 entering a project type into a work station (e.g., receiver for project data 31), in which the project type is fed into the system for providing requirements 100. Referring to FIG. 3, the new project description may be entered into a receiver for project data 31 of a requirements generator 30 of the system for providing requirements 100. The method may further include extracting the project type from the product description in block 6 of FIG. 2. For example, for execution in new projects, when a new project is started, the user will enter the key characteristics of the project into the system 100. The input will be type of project/business/domain/technology, location of its final deployment etc. In some embodiments, a user will fill out data entry field of a user interface being displayed on the monitor of a computer, in which the data entry field is specific to the type of project when entering data into the receiver for project data 31 of the requirement generator 30. In other embodiments, data may be entered by the user for the new project into a data field in sentence and/or paragraph form. In this example, the system for providing requirements 100 may include a natural language classifier 37 for identifying project type from the product data. The natural language classifier 37 can extract the project type from a data entry that is in sentence and/or project form. The natural language classifier 37 of the requirement generator 30 is similar to the natural language classifier 23 for identifying requirements from historical data feeds of the learning engine 20. Therefore, the description of the functionality and hardware for the natural language classifier 23 of the learning engine 20 is suitable for describing at least one example of the functionality and hardware for the natural language classifier 32 of the requirement generator 30.

Referring to block 7 of FIG. 2, the method may further include matching the project type extracted from the project description to the tagged requirements in the database of tagged requirements to project types, e.g., the tagged requirements in the database of characterized historical requirements 24. In some examples, the new project description may include a set of initial requirements. The system can review the project type, the list of initial requirements, and from that information determine whether the list of initial requirements is adequate or not for the project type. For example, the system 100 can determine what requirements are missing from the initial list of requirements, and provide requirements from the database of tagged requirements to project types to fill the missing information. In some examples, once an initial requirement document is created for a new project, it is fed into the system 10. The initial requirements can be recognized by the natural language classifier for identifying project type from project data. The natural language classifier 32 can recognize both project type and the initial list of requirements for the project type.

Referring to FIGS. 1 and 2, in one embodiment, the step of matching the project type extracted from the product description to the tagged requirements, e.g., tagged requirements in the database of characterized historical requirements 24, can be provided by a comparator 33 for matching projector type to requirement tags in the database of characterized historical requirements of the requirement generator 30 of the system for providing requirements 100. In some embodiments, the system 100 can look up its database, e.g., the database of characterized historical requirements 24 of the learning engine 20, for all requirements that have been tagged for these types of projects, or a combination of such projects. Using the matched projects and tagged requirements from the historical projects, a list of requirements can be provided by the system 100 for providing requirements.

The comparator 33 for matching projector type to requirement tags in the database of characterized historical requirements may include at least one processor, e.g., hardware processor, that can actuate a series of commands for comparing a project type that has been entered into the requirement generator 30 to the project types having tagged requirements in the database 24 of characterized historical requirements.

The comparator 33 may employ artificial intelligence (AI) to assign requirements to the new projects from the requirements of the associated historical projects that provided the projects types having the tagged requirements in the database of characterized historical requirements. The comparator 33 may also compare the initial requirements for a new project when they have been provided with the description of the new project to the system 100, and will only provide missing requirements when assigning requirements to the new project.

For example, the comparator 33 can read the initial requirements from the new project and compare them with requirements of other similar projects to come out with possible gaps in terms of completeness. Then the comparator 33 can add requirements to the list of initial requirements for the new project.

Referring to FIGS. 1 and 2, in a following step, the method may continue with generating a report of requirements 11 for the new project at step 8. For example, the user 10 may be communicating with an interface of the user, such as the display of a computer device. The report 11 may be generated in any viewable matter that may be observed by the viewer 12. The report 11 may be printable. Referring to FIG. 2, the system for providing requirements 100 may include a report generator 34. The report generator 34 may be in communication with any interface through which the user is communicating with the system 100. As depicted in FIG. 1, in some embodiments, the viewer 12 may be different than the user 10. The user 10 may be a person that enters the design project type into the system for providing requirements 100, and may be an administrator. The person receiving the report for requirements 11 may be a design professional, such as an architect, software engineer, computer scientist, engineer, chemist, scientist, and/or any scientific/engineering/architecture professional. This can separate administrative functions from professional functions in the process flow beginning with the requirements phase and transitioning to the design phase.

Referring to FIG. 3, the system 100 may also include an update generator 35. The update generator 35 can update the database 24 of characterized historical requirements of new requirements and new requirement/project pairs that are learned through the entry of new projects into the requirement generator.

Referring to FIG. 3, the present disclosure provides a system 100 for generating a requirements report 11. In one embodiment, the system 100 includes a learning engine 20 including a learning receiver 22 for data feeds for requirement data correlated to historical projects, a natural language classifier 23 that employs natural language processing to extract requirement data correlated to project type from the historical projects, and a tag writer 21 for tagging project types with the requirement data and stored in a database of tagged requirements to project type. The system 100 may further include a requirement generator including a receiver for receiving a project description that is analyzed using natural language processing to extract the project type, a comparator for matching the project type extracted from the project description to the tagged requirements of project type, and a report generator for generating a report of requirements 11 including the tagged requirements matching the project type extracted from the project description. Each of the components for the emergency direction system 500 that is depicted in FIG. 2 may be interconnected via a system bus 102.

In some embodiments, the methods and systems described herein can reduce the cost of the projects, compress the schedule of projects, and reduce issue related to scope creep or misses in scope during requirement phase of projects. In some embodiments, the methods and systems described herein can provide a comprehensive requirement document 11 without missing specific domain requirements, technology requirements, nonfunctional requirements or other requirements. In some embodiments, the methods, systems and computer program products described herein can reduce the non-ambiguous nature of requirements by preempting the complete requirement statement. In some embodiments, the methods, systems and computer program products described herein can reduce the number of troubled projects, and reduce a lot of re-work seen in projects due to incomplete requirements.

Any of the systems or machines (e.g., devices) shown in FIG. 3 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed above with respect to FIGS. 1-3, and such a special-purpose computer may, accordingly, be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

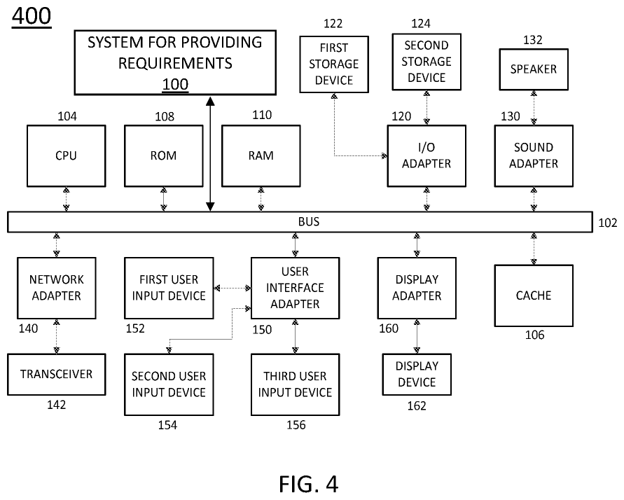

The requirements system 100 may be integrated into the processing system 400 depicted in FIG. 4. The processing system 400 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. The bus 102 interconnects a plurality of components has will be described herein.

The system 400 depicted in FIG. 4, may further include a first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present invention provided herein.

The present invention may be a system, a method, and/or a computer program product at any possible technical detail level of integration. The computer program product can provide a personalized escape plan. The computer program product may include a computer readable storage medium (or media) having computer readable program instructions thereon for causing a processor to carry out aspects of the present invention. For example, the present disclosure provides a computer program product comprising a non-transitory computer readable storage medium having computer readable program code embodied therein for creating a requirement document. The method provided by the steps stored on the computer program product may include receiving data fees for requirement data correlated to historical projects; and using natural language processing to extract requirement data correlated to project type from the historical projects. The project types are tagged with the requirement data and stored in a database of tagged requirements to project type. A project description is analyzed for project type using natural language processing to extract the project type. The method further includes matching the project type extracted from the project description to the tagged requirements of project type. A report is generated of requirements including the tagged requirements matching the project type extracted from the project description.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The methods of the present disclosure may be practiced using a cloud computing environment. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

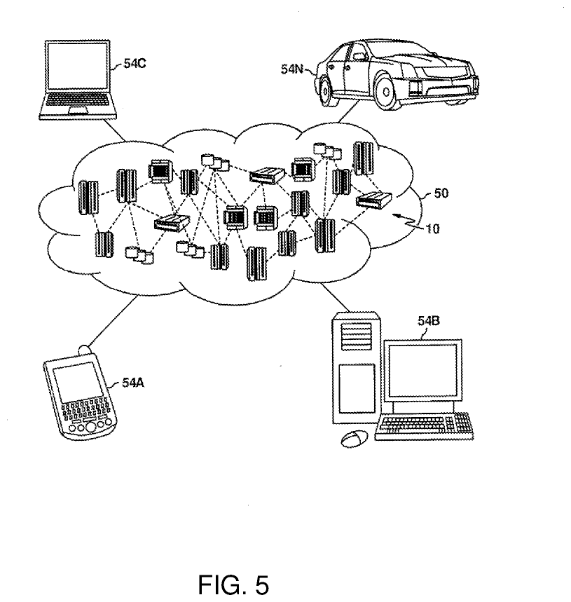

Referring now to FIG. 5, illustrative cloud computing environment 50 is depicted. As shown, cloud computing environment 50 includes one or more cloud computing nodes 51 with which local computing devices used by cloud consumers, such as, for example, mobile and/or wearable electronic devices 54A, desktop computer 54B, laptop computer 54C, and/or automobile computer system 54N may communicate. Nodes 110 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 51 and cloud computing environment 50 can communicate with any type of computerized device over any type of network and/or network addressable connection (e.g., using a web browser).

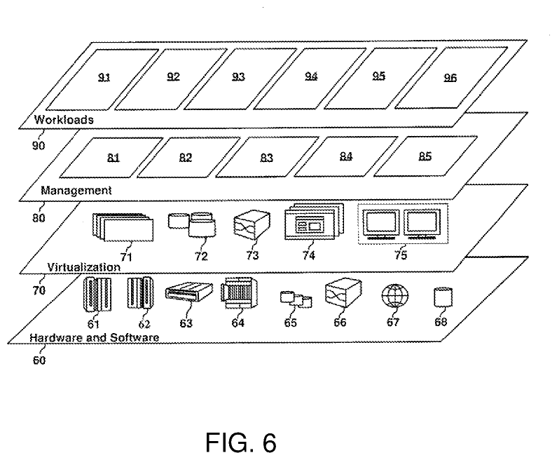

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application for the emergency direction system 500, which is described with reference to FIGS. 1-6.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of requirement creation using self learning mechanism (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer implemented method of creating a requirement document comprising:
receiving data feeds for requirement data correlated to historical projects;
employing natural language processing to extract requirement data correlated to project type from the historical projects;
tagging the project types with the requirement data;
analyzing a project description for project type using natural language processing to extract the project type;
matching the project type extracted from the project description to the tagged requirements of project type; and
generating a report of requirements including the tagged requirements matching the project type extracted from the project description.

2. The computer implemented method of claim 1, further comprising storing a database of tagged requirements to project type.

3. The computer implemented method of claim 1, wherein the receiving data feeds include a feed from a web crawler.

4. The computer implemented method of claim 1, wherein the receiving data feeds include an input from an administrator.

5. The computer implemented method of claim 1, further comprising updating the database of tagged requirements to project type with requirement/project type pairs from the report of requirements.

6. The computer implemented method of claim 1, wherein the requirements may be based on technology, industry, location, or combinations thereof.

7. The computer implemented method of claim 1, wherein the generating of the report of requirements including the tagged requirements matching the project type extracted from the project description includes considering an initial list of requirements from the project description, and providing tagged requirements to fill missing requirements.

8. A system for generating a requirements report comprising:
a learning engine comprising a learning receiver for data feeds for requirement data correlated to historical projects, a natural language classifier that employs natural language processing to extract requirement data correlated to project type from the historical projects, and a tag writer for tagging project types with the requirement data; and
a requirement generator including a receiver for receiving a project description that is analyzed using natural language processing to extract the project type, a comparator for matching the project type extracted from the project description to the tagged requirements of project type, and a report generator for generating a report of requirements including the tagged requirements matching the project type extracted from the project description.

9. The system of claim 8, wherein the learning engine further comprises a database of tagged requirements to project type.

10. The system of claim 8, the learning receiver comprises a input from a web crawler.

11. The system of claim 8, wherein the learning receiver comprises an input from an administrator doing data entry.

12. The system of claim 8, wherein the system further comprises an update generator for updating the database of tagged requirements to project type with requirement/project type pairs from the report of requirements.

13. The system of claim 8, wherein the requirements may be based on technology, industry, location, or combinations thereof.

14. A computer readable storage medium comprising a computer readable program for creating a requirement document, wherein the computer readable program when executed on a computer causes the computer to perform the steps of:
receiving data feeds for requirement data correlated to historical projects;
employing natural language processing to extract requirement data correlated to project type from the historical projects;
tapping the project types with the requirement data;
analyzing a project description for project type using natural language processing to extract the project type;
matching the project type extracted from the project description to the tagged requirements of project type; and
generating a report of requirements including the tagged requirements matching the project type extracted from the project description.

15. The computer readable storage medium of claim 14, wherein the computer readable program when executed on a computer further causes the computer to perform the steps of storing a database of tagged requirements to project type.

16. The computer readable storage medium of claim 14, wherein the receiving data feeds includes a feed from a web crawler.

17. The computer readable storage medium of claim 14, wherein the receiving data feeds includes an input from an administrator.

18. The computer readable storage medium of claim 14, further comprising updating the database of tagged requirements to project type with requirement/project type pairs from the report of requirements.

19. The computer readable storage medium of claim 12, wherein the requirements may be based on technology, industry, location, or combinations thereof.

20. The computer readable storage medium of claim 12, wherein the generating of the report of requirements including the tagged requirements matching the project type extracted from the project description includes considering an initial list of requirements from the project description, and providing tagged requirements to fill missing requirements.
